(19) United States
(12) Patent Application Publication
(10) Pub. No.: US 2016/0328120 A1
(43) Pub. Date: Nov. 10, 2016

(54) Methods and System for Dynamic Spectrum Arbitrage with a Graphic Administration Application

(71) Applicant: Rivada Networks, LLC, Colorado Springs, CO (US)

(72) Inventor: Clint Smith, Warwick, NY (US)

(21) Appl. No.: 14/703,204

(22) Filed: May 4, 2015

(51) Int. Cl. G06F 3/0484; G06F 3/0482; H04W 72/04

(52) U.S. Cl. CPC G06F 3/04842; H04W 72/0493; G06F 3/0482

(57) ABSTRACT

A dynamic spectrum arbitrage (DSA) system includes a dynamic spectrum policy controller (DPC) and a dynamic spectrum controller (DSC) that together dynamically manage the allocation and use of resources (e.g., spectrum resources) across different networks. The DSA system may also include a graphic administration application (GAA) component that is configured to render (or cause a computing device to render) a cell site selection map that identifies a plurality of telecommunication resources in a geographical area, receive input in the displayed cell site selection map selecting one or more of telecommunication resources in the plurality of telecommunication resources, and modify a DSA resource auction or lease based on the received input.

### BACKGROUND

With the ever increasing use of wireless communication devices for accessing networks and downloading large files (e.g., video files), there is an increasing demand for radio frequency spectrum. Smart phone users complain about dropped calls, slow access to the Internet and similar problems which are due largely to too many devices trying to access finite radio frequency (RF) bandwidth allocated to such services. Yet parts of the RF spectrum, such as the RF bands dedicated to emergency services (e.g., police, fire and rescue, etc.), go largely unused due to the non-continuous and episodic employment of such voice-radio communication bands. Therefore, improved methods and solutions for dynamically allocating underutilized telecommunication resources (e.g., RF spectrum, etc.) of a first telecommunication network for access and use by wireless devices that subscribe to other networks will be beneficial to the telecommunication networks, service providers, and to the consumers of telecommunication services.

### SUMMARY

The various aspects include dynamic spectrum arbitrage (DSA) methods that include rendering on an electronic display of a computing device a cell site selection map that identifies a plurality of telecommunication resources in a geographical area, receiving input in the displayed cell site selection map selecting one or more of telecommunication resources in the plurality of telecommunication resources, and modifying a DSA resource auction based on the received input. In an embodiment, modifying a DSA resource auction based on the received input may include adding or removing a telecommunication resource to the DSA resource auction.

In a further aspect, the DSA method may further include performing operations to accomplish one or more of a login authentication function, an auctions dashboard function, a create auction function, a view auctions function, a resource modify function, a lease management function, a telecommunication resource/asset management function, and a bid grid management function. In a further aspect, performing operations to accomplish one or more of a login authentication function, an auctions dashboard function, a create auction function, a view auctions function, a resource modify function, a lease management function, a telecommunication resource/asset management function, and a bid grid management function includes performing operations selected from the group including administering a telecommunication resource allocation scheme, creating a resource auction, listing resources available for the auction, displaying information about the resources that are offered via the auction, the information including congestion level information, generating a lease for the use the resources in a geographical area identified via the cell site selection map, managing telecommunication resources offered for lease, managing functionalities of the telecommunication resources offered for lease, generating a bid grid, updating the bid grid, and providing cell type classification list information for each telecommunication resource associated with the bid grid.

In a further aspect, the computing device may be included in a first telecommunication network of a plurality of communication networks, and the DSA method may further include conducting the DSA resource auction by performing operations that include communicating with a communications server, establishing a communication link between the communications server and the plurality of communication networks, determining in the communications server whether a telecommunication resource of the first communication network of the plurality of communication networks is available for allocation based on information received via the communication link, broadcasting a communication signal that includes information suitable for informing the plurality of communication networks that the telecommunication resource is available for allocation via auction and including an auction start time for the auction, receiving credential information from the plurality of communication networks, the credential information identifying a type of geographic area, a wireless access technology, a frequency of operation, an amount of bandwidth, a duration for use of the telecommunication resource, a start time, and an end time, using the received credential information to determine that one or more networks in the plurality of communication networks is eligible to participate in the auction, in which the one or more communication networks determined to be eligible to participate in the auction includes a second communication network, receiving bids from the plurality of communication networks for the telecommunication resource determined to be available for allocation in response to broadcasting the communication message and after the auction start time included in the broadcast communication signal, accepting only the bids received from the plurality of communication networks determined to be eligible to participate in the auction, allocating the telecommunication resource of the first communication network for access and use by the second communication network in the plurality of communication networks based on accepted bids, sending a communication message to the second communication network, the communication message including information suitable for informing the second communication network that use of allocated telecommunication resource may begin, and recording a transaction in a transaction database identifying the telecommunication resource as being allocated for use by the second communication network.

In a further aspect, the computing device is included in a first telecommunication network of a plurality of communication networks, the method further including establishing a first communication link between a communications server and a first server in the first communication network, in which an amount of RF spectrum resources is controlled by the first communication network, establishing a second communication link between the communications server and a second server in a second communication network, receiving in the communications server a request for radio frequency (RF) spectrum resources from the second server, determining in the communications server an amount of RF spectrum resources available for allocation within the first communication network, dynamically allocating a portion of the available RF spectrum resources of the first communication network for access and use by multiple cell sites in the second communication network from a pool of available RF spectrum resources, informing the second server that use of allocated RF spectrum resources may begin, and recording a transaction in a transaction database identifying an amount of RF spectrum resources allocated for use by the second communication network.

Further aspects may include a server computing device, which may be deployed as part of a dynamic spectrum arbitrage (DSA) system and coupled to a dynamic spectrum controller in a first communication network, that includes a processor configured with processor-executable instructions to perform operations that include rendering a cell site selection map that identifies a plurality of telecommunication resources in a geographical area, receiving input in the displayed cell site selection map selecting one or more of telecommunication resources in the plurality of telecommunication resources, and modifying a DSA resource auction based on the received input. In an aspect, the processor may be configured with processor executable instructions to perform operations such that modifying a DSA resource auction based on the received input includes sending a communication message to the dynamic spectrum controller to add or remove a telecommunication resource to the DSA resource auction. In a further aspect, the processor is configured with processor executable instructions to perform operations to accomplish one or more of a login authentication function, an auctions dashboard function, a create auction function, a view auctions function, a resource modify function, a lease management function, a telecommunication resource/asset management function, and a bid grid management function.

In a further aspect, the processor is configured with processor executable instructions to perform operations such that performing operations for accomplishing or more of a login authentication function, an auctions dashboard function, a create auction function, a view auctions function, a resource modify function, a lease management function, a telecommunication resource/asset management function, and a bid grid management function includes performing operations selected from the group including administering a telecommunication resource allocation scheme, creating a resource auction, listing resources available for the auction, displaying information about the resources that are offered via the auction, the information including congestion level information, generating a lease for the use the resources in a geographical area identified via the cell site selection map, managing telecommunication resources offered for lease, managing functionalities of the telecommunication resources offered for lease, generating a bid grid, updating the bid grid, and providing cell type classification list information for each telecommunication resource associated with the bid grid.

In a further aspect, the processor may be configured with processor executable instructions to perform operations such that modifying a DSA resource auction based on the received input includes communicating with a communication device that may be configured to conduct the DSA resource auction by establishing a communication link between the communication device and a plurality of communication networks, determining whether a telecommunication resource of the first communication network in the plurality of communication networks is available for allocation based on information received via the communication link, broadcasting a communication signal that includes information suitable for informing the plurality of communication networks that the telecommunication resource is available for allocation via auction and including an auction start time for the auction, receiving credential information from the plurality of communication networks, the credential information identifying a type of geographic area, a wireless access technology, a frequency of operation, an amount of bandwidth, a duration for use of the telecommunication resource, a start time, and an end time, using the received credential information to determine that one or more networks in the plurality of communication networks is eligible to participate in the auction, in which the one or more communication networks determined to be eligible to participate in the auction includes a second communication network, receiving bids from the plurality of communication networks for the telecommunication resource determined to be available for allocation in response to broadcasting the communication message and after the auction start time included in the broadcast communication signal, accepting only the bids received from the plurality of communication networks determined to be eligible to participate in the auction, allocating the telecommunication resource of the first communication network for access and use by the second communication network in the plurality of communication networks based on accepted bids, sending a communication message to the second communication network, the communication message including information suitable for informing the second communication network that use of allocated telecommunication resource may begin, and recording a transaction in a transaction database identifying the telecommunication resource as being allocated for use by the second communication network.

In a further aspect, the processor may be configured with processor executable instructions to perform operations such that modifying a DSA resource auction based on the received input includes communicating with communicating with a communications server that may be configured to perform DSA operations by establishing a first communication link between the communications server and a first server in the first communication network, in which an amount of RF spectrum resources is controlled by the first communication network, establishing a second communication link between the communications server and a second server in a second communication network, receiving in the communications server a request for radio frequency (RF) spectrum resources from the second server, determining in the communications server an amount of RF spectrum resources available for allocation within the first communication network, dynamically allocating a portion of the available RF spectrum resources of the first communication network for access and use by multiple cell sites in the second communication network from a pool of available RF spectrum resources, informing the second server that use of allocated RF spectrum resources may begin, and recording a transaction in a transaction database identifying an amount of RF spectrum resources allocated for use by the second communication network.

Further aspects may include include a non-transitory computer readable storage medium having stored thereon processor-executable software instructions configured to cause a processor of a server computing device (which may be deployed as part of a dynamic spectrum arbitrage (DSA) system and coupled to a dynamic spectrum controller in a first communication network) to perform operations that include rendering a cell site selection map that identifies a plurality of telecommunication resources in a geographical area, receiving input in the displayed cell site selection map selecting one or more of telecommunication resources in the plurality of telecommunication resources, and modifying a DSA resource auction based on the received input. In a further aspect, the stored processor-executable software instructions may be configured to cause a processor to perform operations such that modifying a DSA resource auction based on the received input includes sending a communication message to the dynamic spectrum controller to add or remove a telecommunication resource to the DSA resource auction.

In an aspect, the stored processor-executable software instructions may be configured to cause a processor to perform operations to accomplish one or more of a login authentication function, an auctions dashboard function, a create auction function, a view auctions function, a resource modify function, a lease management function, a telecommunication resource/asset management function, and a bid grid management function. In a further aspect, the stored processor-executable software instructions may be configured to cause a processor to perform operations such that performing operations for accomplishing or more of a login authentication function, an auctions dashboard function, a create auction function, a view auctions function, a resource modify function, a lease management function, a telecommunication resource/asset management function, and a bid grid management function includes performing operations selected from the group including administering a telecommunication resource allocation scheme, creating a resource auction, listing resources available for the auction, displaying information about the resources that are offered via the auction, the information including congestion level information, generating a lease for the use the resources in a geographical area identified via the cell site selection map, managing telecommunication resources offered for lease, managing functionalities of the telecommunication resources offered for lease, generating a bid grid, updating the bid grid, and providing cell type classification list information for each telecommunication resource associated with the bid grid. In a further aspect, the stored processor-executable software instructions may be configured to cause a processor to perform operations such that modifying a DSA resource auction based on the received input includes communicating with a communication device that may be configured to conduct the DSA resource auction by establishing a communication link between the communication device and a plurality of communication networks, determining whether a telecommunication resource of the first communication network in the plurality of communication networks is available for allocation based on information received via the communication link, broadcasting a communication signal that includes information suitable for informing the plurality of communication networks that the telecommunication resource is available for allocation via auction and including an auction start time for the auction, receiving credential information from the plurality of communication networks, the credential information identifying a type of geographic area, a wireless access technology, a frequency of operation, an amount of bandwidth, a duration for use of the telecommunication resource, a start time, and an end time, using the received credential information to determine that one or more networks in the plurality of communication networks is eligible to participate in the auction, in which the one or more communication networks determined to be eligible to participate in the auction includes a second communication network, receiving bids from the plurality of communication networks for the telecommunication resource determined to be available for allocation in response to broadcasting the communication message and after the auction start time included in the broadcast communication signal, accepting only the bids received from the plurality of communication networks determined to be eligible to participate in the auction, allocating the telecommunication resource of the first communication network for access and use by the second communication network in the plurality of communication networks based on accepted bids, sending a communication message to the second communication network, the communication message including information suitable for informing the second communication network that use of allocated telecommunication resource may begin, and recording a transaction in a transaction database identifying the telecommunication resource as being allocated for use by the second communication network.

In a further aspect, the stored processor-executable software instructions may be configured to cause a processor to perform operations such that modifying a DSA resource auction based on the received input includes communicating with communicating with a communications server that may be configured to perform DSA operations by establishing a first communication link between the communications server and a first server in the first communication network, in which an amount of RF spectrum resources is controlled by the first communication network, establishing a second communication link between the communications server and a second server in a second communication network, receiving in the communications server a request for radio frequency (RF) spectrum resources from the second server, determining in the communications server an amount of RF spectrum resources available for allocation within the first communication network, dynamically allocating a portion of the available RF spectrum resources of the first communication network for access and use by multiple cell sites in the second communication network from a pool of available RF spectrum resources, informing the second server that use of allocated RF spectrum resources may begin, and recording a transaction in a transaction database identifying an amount of RF spectrum resources allocated for use by the second communication network.

### BRIEF DESCRIPTION OF THE DRAWINGS

The accompanying drawings, which are incorporated herein and constitute part of this specification, illustrate exemplary embodiments of the invention, and, together with the general description given above and the detailed description given below, serve to explain features of the invention.

FIGS. 1A and 1B are system block diagrams illustrating various logical and functional components and communication links in communication systems that may be used to implement the various embodiments.

FIG. 1C and 1D are a system block diagrams illustrating various components and communication links in communication systems equipped with graphic administration application (GAA) components that are suitable for performing DSA operations in accordance with the various embodiments.

FIG. 2 is a system block diagram illustrating the components and information flows of a GAA component configured to perform DSA operations in accordance with the various embodiments.

FIG. 3 is an illustration of a data model that may be implemented and used by an embodiment GAA component to perform DSA operations.

FIG. 4 is a process flow diagram illustrating an embodiment method for generating a DSA resource auction in accordance with an embodiment.

FIG. 5 is a process flow diagram illustrating an embodiment method for rendering a current auctions list.

FIG. 6 is a process flow diagram illustrating an embodiment method for performing DSA operations to allocate a telecommunication resources of a first network for access and use by wireless devices that subscribe to another network.

FIG. 7 is a component block diagram of an example wireless device suitable for use with the various embodiments.

FIG. 8 is a component block diagram of a server suitable for use with an embodiment.

### DETAILED DESCRIPTION

The various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the invention or the claims.

As used herein, the terms “mobile device,” “wireless device” and “user equipment (UE)” may be used interchangeably and refer to any one of various cellular telephones, personal data assistants (PDA's), palm-top computers, laptop computers with wireless modems, wireless electronic mail receivers (e.g., the Blackberry® and Treo® devices), multimedia Internet enabled cellular telephones (e.g., the iPhone®), and similar personal electronic devices. A wireless device may include a programmable processor and memory. In a preferred embodiment, the wireless device is a cellular handheld device (e.g., a wireless device), which can communicate via a cellular telephone communications network.

A high priority in responding to any emergency or disaster situation is establishing effective communications. In large scale emergency or disaster (both manmade and natural) situations, it is paramount to maintain communications between all first responders and emergency personnel in order to respond, manage, and control the emergency situation effectively. In the absence of effective communication among first responders and other emergency personnel, resources may not be effectively mobilized to the areas which need the resources most. Even in minor emergency situations (e.g., traffic accidents and fires), first responders must be able to call on support assets and coordinate with other services (e.g., public utilities, hospitals, etc.).

With the ubiquity of wireless device ownership and usage, emergency communication via wireless devices using commercial cellular communication networks often are the most efficient and effective means to mobilize emergency response personnel and resources. Enabling wireless devices to provide effective emergency communications obviates the technical challenges and expense of coordinating radio frequencies among various first responder agencies (e.g., police, fire, ambulance, FEMA, public utilities, etc.). Also, qualified first responders to an accident who are off duty or not ordinarily equipped with radios (e.g., doctors, nurses, retired police, or military personnel) will have or can quickly borrow a wireless device.

Emergency communications over cellular communication networks is not without problems, however. Cellular and other telecommunication networks (“networks”) are designed to accommodate access requests from only a fraction of the total number of wireless devices in a particular cell. At times of emergency or crisis, network resources may become overtaxed when predictable human responses to the situation prompt an extraordinary number of wireless device users within a particular cell to access the network at the same time. Wireless device users may be attempting to alert emergency personnel of the emergency situation (such as a 911 emergency call) or to alert friends or family members that the user is safe despite being in the area of an emergency situation. Some users may be transmitting images of the emergency condition (fire, accident, etc.) to news services or friends. In a wide scale situation, emergency responders using wireless devices for emergency communications will add to the call volume. Regardless, the predictable increase in call volume during an emergency situation can overwhelm a commercial cellular communications network, particularly in the cell zone encompassing the emergency, thus rendering the network unreliable for emergency response personnel communication usage.

To overcome these and other limitations of existing solutions, the various embodiments include components configured to provide tiered priority access (TPA) capabilities to deliver quality of service (QoS) and grade of service (GoS) based wireless device communications for first responders. Detailed descriptions of example TPA systems are provided in U.S. Pat. No. 8,275,349 dated Sep. 25, 2102, the entire contents of which are hereby incorporated by reference in their entirety and for all purposes.

In overview, a TPA system or solution may include various components configured to perform various TPA operations to coordinate, make available and/or provide wireless communication resources to high priority users (e.g., emergency personnel) during times of high congestion or in emergency situations. For example, TPA components may be configured to monitor a wireless network's call volume, determine whether the wireless network call volume exceeds a first pre-determined threshold, partition the wireless network resources based on priorities when the wireless network call volume exceeds the first pre-determined threshold, and reserve a portion of the partitioned resources for high priority usage (i.e., use by wireless devices of authorized emergency personnel). The TPA components may be further configured to monitor incoming and outgoing calls to determine whether a call is made from or to an high priority device (e.g., to or from a pre-registered wireless device or wireless devices of authorized emergency personnel), allow general access to the wireless network resources so long as no call is made from or to high priority device, and restrict general access to the wireless network resources in response to determining that a call is made to or from a high priority device. As such, TPA solutions allow telecommunication systems use more the available resources, and ensure that high priority users can access and use the system when needed.

In various embodiments, these and other TPA operations may be performed in (or in conjunction with) a dynamic spectrum arbitrage (DSA) system configured to dynamically manage the availability, allocation, access, and use of telecommunication resources (e.g., RF spectrum, etc.) between two or more networks (e.g., between a lessor network and a lessee network). A detailed description of an example DSA system is provided in U.S. Pat. No. 8,711,721 dated Apr. 29, 2014, the entire contents of which are hereby incorporated by reference in their entirety and for all purposes. Briefly, a DSA system may include a dynamic spectrum policy controller (DPC) configured to manage the DSA operations and interactions between two or more networks (e.g., between a lessor network and a lessee network). The DPC may communicate with various network components in a network provider network through one or more dynamic spectrum controller (DSC) components, which may be included in or added to the networks participating in the DSA communications. The DSC component may include wired or wireless connections to eNodeBs, a mobility management entity (MME) component/server, various satellite systems, and other network components, and communicate with the DPC component to offer, allocate, request, and/or receive resources to and from other networks. As such, the DSA system allows two or more networks to collaborate and make better use their resources, such as by leasing resources during times of high congestion and/or leasing out resources when the resources are not in use.

In addition, the DSA system (e.g., the TPA-DSA system) may include a telecommunications commodity exchange (TCE) component that allows lessor networks to offer their unused or underutilized resources for use by other networks via a resource lease, and for bidder networks to submit bids to lease those resources. Details of example TCE systems are provided in U.S. Pat. No. 8,717,929 dated May 6, 2014, the entire contents of which are hereby incorporated by reference for all purposes.

Briefly, a TCE system may be configured to determine that a telecommunication resource of a first communication network is available for allocation, broadcast a communication signal that informs other networks that a telecommunication resource or resource lease may be procured via auction, receive bids from bidder networks for the rights to access and use that resource, and allocate the resource for access and use by wireless devices that subscribe to a bidder network that submitted a winning bid. Further, the DSA system (e.g., the TPA-DSA-TCE system) may be configured to offer for lease, allocate, and/or manage the telecommunication resources based on geographic areas (e.g., a license area, regional area, cell/sector region, subsector cell region, etc.). A bid grid may be a representation of, or an information structure that includes information suitable for identifying, the geographic area that is made available for lease, won by a lessee network as part of the TPA-DSA-TCE operations, etc.

In addition, DSA system may include components that are configured to perform resource allocation, modification, or release operations, dynamic spectrum arbitrage operations, and geo-fencing operations. For example, the DSA system may use priorities, short-term leases, and geographic information to dynamically allocate telecommunication resources of a first network for access and use by wireless devices that subscribe to another network such that the wireless device may being using the allocated resources as if the leased resources were included as part of their home network (i.e., the first network). As a result, the DSA system allows capacity-constrained telecommunication operator networks to dynamically request and receive congestion relief (e.g., by leasing additional resources), provides new revenue streams for networks that include unused or underutilized resources (e.g., by leasing-out those resources to the highest bidder), and improves the customer experience (e.g., by providing wireless device user with faster and more reliable network communications, reducing the cost of their subscription plans, etc.).

To further improve the performance, efficiency and usability of the DSA system and of the DSA components/devices, various embodiment DSA systems may be equipped with a graphic administration application (GAA) component that is configured to perform various operations to provide the DSA system, the network operator, and/or participating networks with an additional degree of coordination and control over the resource auctions and/or the resources that are offered for lease via an auction. As such, the GAA component improves the functioning of the devices and components in the DSA system by an additional degree of coordination and control over the resource auctions and/or the resources that are offered for lease via an auction.

The GAA component may be configured to generate, provide, or include a graphical user interface that may be used by the network operator (e.g., or users, modules, or devices in the lessee and/or lessor networks) to create and administer a lease within the DSA ecosystem. The GAA component may interact or communicate with the local DSCs associated with the telecommunications network for both the lessee and lessor of a leased telecommunication resource that is leased or offered for lease. In addition, GAA components in the lessee and lessor networks may communicate with an arbitrage entity (AE) that is configured to provide a trading platform and/or conduct an auction for offer and procure resource leases for the use of telecommunication resources. For example, a GAA component in a lessor network may send lease attributes to the AE component, which may use or update the lease attributes and send them to a GAA component in a lessee network. In some embodiments, the AE component may be included in or implemented as part of a TCE component/system. In other embodiments, the AE may be included in or implemented as part of a commercially available or over the counter (OTC) trading platform.

In various embodiments, the GAA component may be configured to perform various operations to accomplish various GAA functions, including a login authentication function, an auctions dashboard function, a create auction function, a view auctions function, a resource modify function, a lease management function, telecommunication resource/asset management function, and a bid grid management function. As part of these operations, the GAA component may administer a telecommunication resource allocation scheme. Also as part of these operations, the GAA component may perform operations that allow participating networks (e.g., a lessor network, a potential lessee network, etc.) to quickly and efficiently create a resource auction, list/publish the resources for the auction or lease, analyze or view information about the resources that are offered for lease via the auction (e.g., current congestion levels, compatibility, etc.), and procure a lease for the use a resource in a geographical area. In addition, the GAA component may be configured to perform operations that allow participating networks to manage existing or potential leases (e.g., by altering the terms of the lease, etc.), manage telecommunication resources offered for lease (e.g., by adding, altering, updating, modifying or removing a resource from particular lease or bid area, etc.), manage the functionalities of the telecommunication resources that are offered for lease, manage a bid grid (or the geographical area made available for lease or won by a lessee network as part of the DSA operations), provide cell type classification list information for each telecommunication resource/asset (e.g., eNodeB) associated with the bid grid, or perform similar operations that improve the usability and/or functionality of the DSA system.

In some embodiments, the login authentication function of the GAA component may include providing users or client device with access to information and functionality for viewing, on a map, the resources (e.g., cells, cell sites, etc.) that are leased or offered for lessee, the congestion levels of those resources, neighboring resources, etc. The auctions dashboard function may include displaying (e.g., via a map or GUI) leases that have been saved but not yet been published (e.g., leases having a status=“Pending”), leases that have been published (e.g., leases having a status=“Bidding”), DSC registration information, grid ids, and other similar information.

The create auction function may include displaying a map, and allowing a user to draw/indicate a lease polygon on the map (e.g., an area bounded by 4 to 8 points that is created via a mouse or pointing device) and/or enter other lease parameters. Example lease parameters include operator id, grid polygon as kml, lease start, lease end, bid start time, bid end time, data volume, minimum amount, and buy price. The create auction function may also include saving the lease in a local memory, publishing the lease, and/or perform other similar operations.

The view auctions function may include displaying saved or published auctions so that they may be analyzed for potential bidding. The resource modify function may include displaying available or leased resources on a map, and allowing a user to input information (via the map) to add, remove, change, or alter a telecommunications resource (e.g., select a new resource for the lease, remove a resource due to performance issues, etc.). The resource modify function may include allowing the user to add a telecommunications resource to a blacklist or a whitelist and/or perform other similar operations via the displayed map.

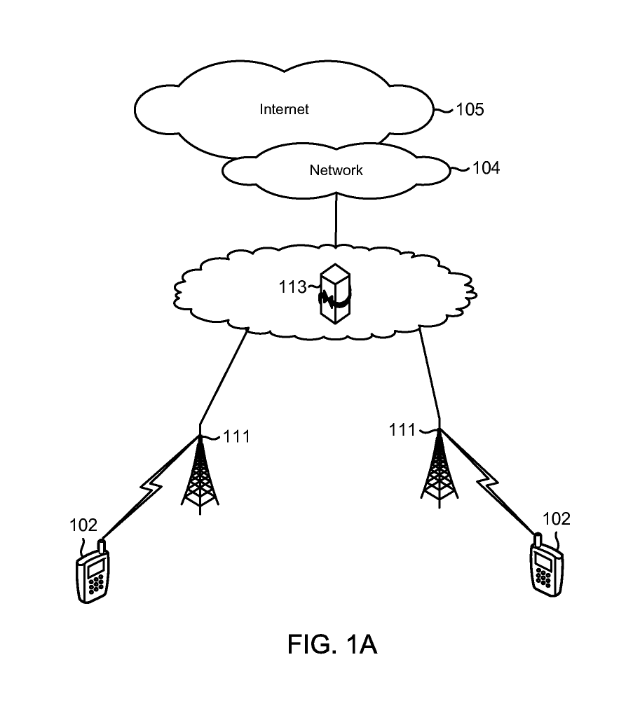

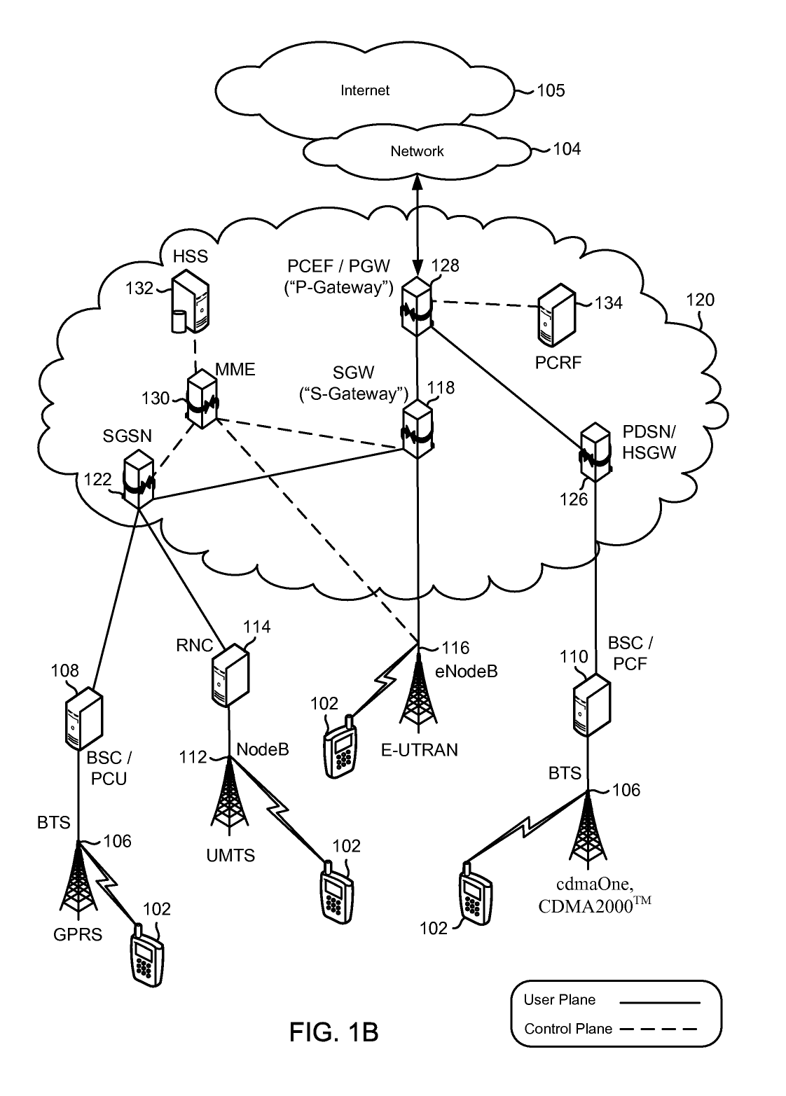

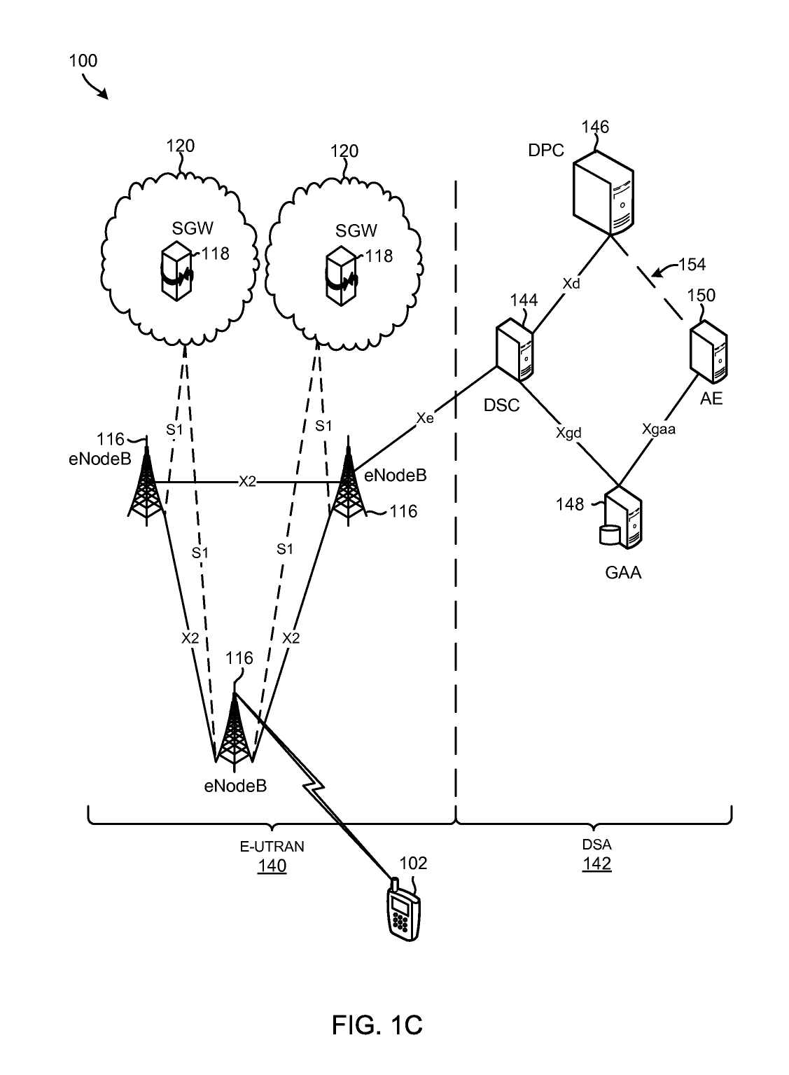

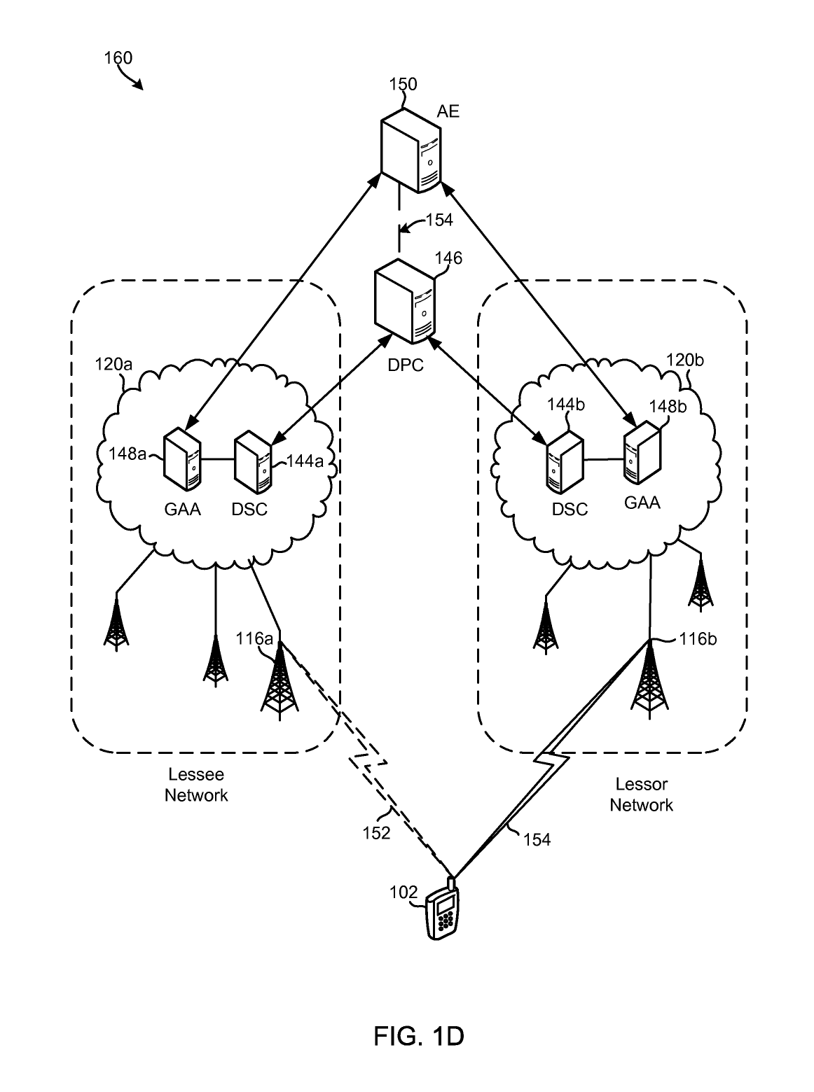

The various embodiments may be implemented within a variety of communication systems, examples of which are illustrated in FIGS. 1A-1D. With reference to FIG. 1A, wireless devices 102 may be configured to transmit and receive voice, data, and control signals to and from a base station 111, which may be a base transceiver station (BTS), NodeB, eNodeB, etc. The base station 111 may communicate with an access gateway 113, which may include one or more of a controller, a gateway, a serving gateway (SGW), a packet data network gateway (PGW), an evolved packet data gateway (ePDG), a packet data serving node (PDSN), a serving GPRS support node (SGSN), or any similar component or combinations of the features/functions provided thereof. Since these structures are well known and/or discussed in detail further below, certain details have been omitted from FIG. 1A in order to focus the descriptions on the most relevant features.

The access gateway 113 may be any logical and/or functional component that serves as the primary point of entry and exit of wireless device traffic and/or connects the wireless devices 102 to their immediate service provider and/or packet data networks (PDNs). The access gateway 113 may forward the voice, data, and control signals to other network components as user data packets, provide connectivity to external packet data networks, manage and store contexts (e.g. network internal routing information, etc.), and act as an anchor between different technologies (e.g., 3GPP and non-3GPP systems). The access gateway 113 may coordinate the transmission and reception of data to and from the Internet 105, as well as the transmission and reception of voice, data and control information to and from an external service network 104, the Internet 105, other base stations 111, and to wireless devices 102.

In various embodiments, the base stations 111 and/or access gateway 113 may be coupled (e.g., via wired or wireless communication links) to a dynamic spectrum arbitrage (DSA) system configured to dynamically manage the availability, allocation, access, and use of various network resources (e.g., RF spectrum, RF spectrum resources, etc.). The DSA system is discussed in detail further below.

FIG. 1B illustrates that wireless devices 102 may be configured to send and receive voice, data and control signals to and from the service network 104 (and ultimately the Internet 105) using a variety of communication systems/technologies (e.g., GPRS, UMTS, LTE, cdmaOne, CDMA2000™), any or all of which may be supported by, or used to implement, the various embodiments.

In the example illustrated in FIG. 1B, long term evolution (LTE) and/or evolved universal terrestrial radio access network (E-UTRAN) data transmitted from a wireless device 102 is received by an eNodeB 116, and sent to a serving gateway (SGW) 118 located within the core network 120. The eNodeB 116 may send signaling/control information (e.g., information pertaining to call setup, security, authentication, etc.) to a mobility management entity (MME) 130. The MME 130 may request user/subscription information from a home subscriber server (HSS) 132, communicate with other MME components, perform various administrative tasks (e.g., user authentication, enforcement of roaming restrictions, etc.), select a SGW 118, and send authorization and administrative information to the eNodeB 116 and/or SGW 118. Upon receiving the authorization information from the MME 130 (e.g., an authentication complete indication, an identifier of a selected SGW, etc.), the eNodeB 116 may send data received from the wireless device 102 to a selected SGW 118. The SGW 118 may store information about the received data (e.g., parameters of the IP bearer service, network internal routing information, etc.) and forward user data packets to a policy control enforcement function (PCEF) and/or packet data network gateway (PGW) 128.

FIG. 1B further illustrates that general packet radio service (GPRS) data transmitted from the wireless devices 102 may be received by a base transceiver station (BTS) 106 and sent to a base station controller (BSC) and/or packet control unit (PCU) component (BSC/PCU) 108. Code division multiple access (CDMA) data transmitted from a wireless device 102 may be received by a base transceiver station 106 and sent to a base station controller (BSC) and/or packet control function (PCF) component (BSC/PCF) 110. Universal mobile telecommunications system (UMTS) data transmitted from a wireless device 102 may be received by a NodeB 112 and sent to a radio network controller (RNC) 114.

The BSC/PCU 108, BSC/PCF 110, and RNC 114 components may process the GPRS, CDMA, and UMTS data, respectively, and send the processed data to a component within the core network 120. More specifically, the BSC/PCU 108 and RNC 114 units may send the processed data to a serving GPRS support node (SGSN) 122, and the BSC/PCF 110 may send the processed data to a packet data serving node (PDSN) and/or high rate packet data serving gateway (HSGW) component (PDSN/HSGW) 126. The PDSN/HSGW 126 may act as a connection point between the radio access network and the IP based PCEF/PGW 128. The SGSN 122 may be responsible for routing the data within a particular geographical service area, and send signaling (control plane) information (e.g., information pertaining to call setup, security, authentication, etc.) to an MME 130. The MME 130 may request user and subscription information from a home subscriber server (HSS) 132, perform various administrative tasks (e.g., user authentication, enforcement of roaming restrictions, etc.), select a SGW 118, and send administrative and/or authorization information to the SGSN 122.

The SGSN 122 may send the GPRS/UMTS data to a selected SGW 118 in response to receiving authorization information from the MME 130. The SGW 118 may store information about the data (e.g., parameters of the IP bearer service, network internal routing information, etc.) and forward user data packets to the PCEF/PGW 128. The PCEF/PGW 128 may send signaling information (control plane) to a policy control rules function (PCRF) 134. The PCRF 134 may access subscriber databases, create a set of policy rules and performs other specialized functions (e.g., interacts with online/offline charging systems, application functions, etc.). The PCRF 134 may then send the policy rules to the PCEF/PGW 128 for enforcement. The PCEF/PGW 128 may implement the policy rules to control the bandwidth, the quality of service (QoS), the characteristics of the data, and the services being communicated between the service network 104 and the end users.

In the various embodiments, any or all of the components discussed above (e.g., components 102-134) may be coupled to, or included in, a DSA system configured to dynamically manage the availability, allocation, access, and use of telecommunication resources.

FIG. 1C illustrates various logical components and communication links in a system 100 that includes an DSA system 142 and a evolved universal terrestrial radio access network (E-UTRAN) 140. In the example illustrated in FIG. 1C, the DSA system 142 includes a dynamic spectrum controller (DSC) 144 component, a dynamic spectrum policy controller (DPC) 146 component, a graphic administration application (GAA) 148 component, and an arbitrage entity (AE) 150 component. The E-UTRAN 140 includes a plurality of interconnected eNodeBs 116 coupled to the core network 120 (e.g., via a connection to an SGW 118, etc.). In some embodiments, the DSC 144, GAA 148, and/or AE 150 may be included in or coupled to the E-UTRAN 140, either as part of its core network 120 or outside of the core network 120. In an embodiment, the DSC 144 may be coupled directly (e.g., via wired or wireless communication links) to one or more of the eNodeBs 116. In some embodiments, the AE 150 component may be included in, or implemented as part of, a telecommunications commodity exchange (TCE) system, component, or module.

The DPC 146 and DSC 144 components of the DSA system 142 may be configured to communicate via an interface that is implemented in, or provided via, a dynamic spectrum arbitrage application part (DSAAP) protocol, module, or component. The DSAAP module/component may be configured to allow, facilitate, support or augment communications between various DSA components (e.g., DPC 146, DSC 144, GAA 148, AE 150, etc.). For example, the DSC 144 may be configured to communicate with the DPC 146 via an Xd interface/reference point using the DSAAP protocol. Similarly, the DSC 144 may be configured to communicate with the GAA 148 via the Xgd interface/reference point using the DSAAP protocol, and the GAA 148 may be configured to communicate with the AE 150 via the Xgaa interface/reference point using the DSAAP protocol. In some embodiments, the AE 150 may also be coupled to the DPC 146 component via a direct wired or wireless communication link 154.

The Xgd interface/reference point may include or provide features, functions, or operations that allow the system or its components (e.g., the GAA 148 component) to perform various operations, including registering a DSC 144, registering a telecommunication resource (e.g., an eNodeB, etc.), de-registering the resource, obtaining periodic update information (e.g., congestion information, etc.) about the resource, defining a resource allocation, releasing an allocated resource (e.g., via a resource release operation), modifying the resource offered for a lease, and modifying the resource during a lease, such as by selecting/identifying a resource, blacklisting the resource, whitelisting the resource, or changing the resource (e.g., changing a cell type from “interior cell” to “buffer cell”, etc.). The Xgaa interface may facilitate the ability to add or list a contract/resource/lease for bidding on the AE 150 component, and enable the GAA 148 to obtain existing auction/lease information.

The eNodeBs 116 may be interconnected, and configured to communicate via an X2 interface/reference point using the DSAAP protocol. The eNodeBs 116 may be configured to communicate with the DSC 144 via the Xe interface/reference point, which may use the DSAAP protocol, TR-069 protocol, and/or TR-192 data model extensions (e.g., to support listing available resources at the eNodeB 116, notify the eNodeB 116 of bid/buy confirmations, etc.). The eNodeBs 116 may be configured to communicate with components in the core network 120 via the S1 interface. For example, an eNodeB 116 may be connected to an MME 130 via the S1-MME interface, and connected to a SGW 118 via the S1-U interface.

The eNodeBs 116 may act as a bridge (e.g., layer 2 bridge) between the wireless devices 102 and the core network 120 by serving as the termination point of all radio protocols towards the wireless devices 102, and relaying voice (e.g., VoIP, etc.), data, and control signals to network components in the core network 120. The eNodeBs 116 may also be configured to perform various radio resource management operations, which may include controlling the usage of radio interfaces, allocating resources based on requests, prioritizing and scheduling traffic according to various quality of service (QoS) requirements, monitoring the usage of network resources, and performing other similar operations. In addition, in some embodiments, the eNodeBs 116 may be configured to collect radio signal level measurements, analyze the collected radio signal level measurements, and handover wireless devices 102 (or connections to the mobile devices) to other base stations (e.g., a second eNodeB) based on the analysis of the collected radio signal level measurements.

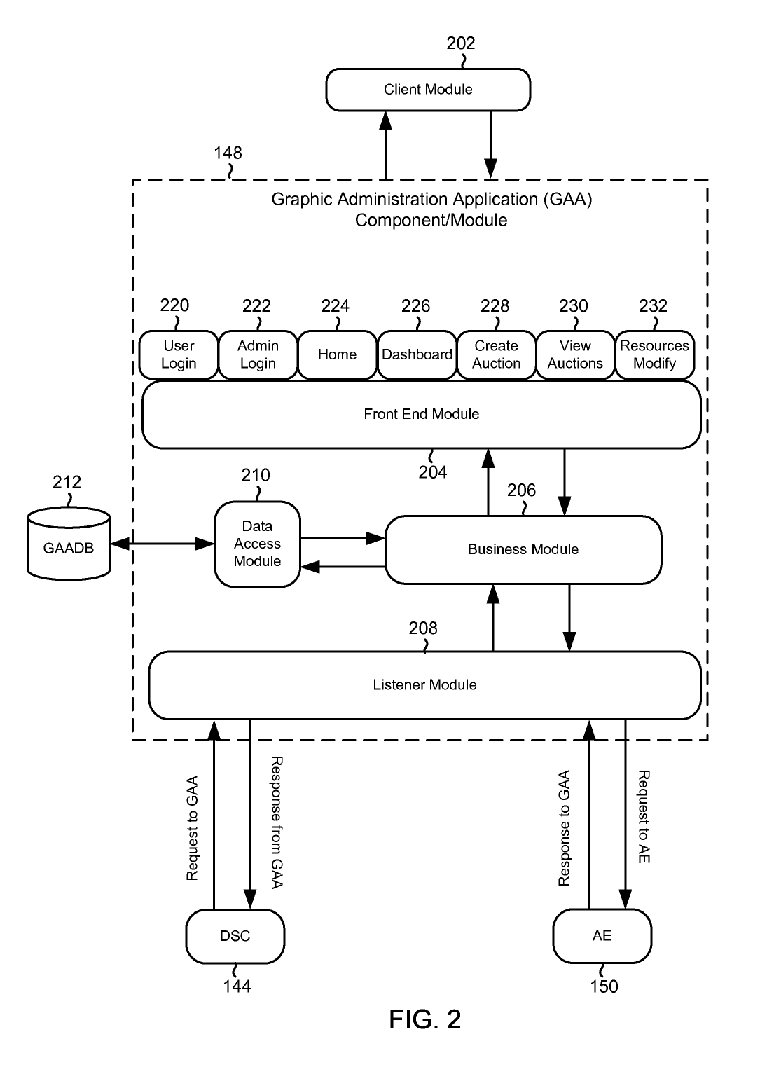

FIG. 1D illustrates network components and information flows in an example communication system 160 that includes two E-UTRANs 140a, 140b interconnected via a DPC 146 that is configured to manage DSA operations and interactions between the E-UTRANs 140a, 140b. Each E-UTRAN 140a, 140b may include a core network 120a, 120b, an eNodeB 116a, 116b, a DSC 144a, 144b, and a GAA 148a, 148b. The DSCs 144a, 144b may connected, directly or indirectly, to an AE 150 component. The DSCs 144a, 144b may also be connected, directly or indirectly, to various network components in their respective core networks 120a, 120b, such as a PCRF 134, HSS 132 and a PCEF/PGW 128 (not illustrated in FIG. 2). The DSCs 144a, 144b may be connected to the eNodeBs 116a, 116b via direct or indirect communication links. The wireless device 102 may be a lessee wireless device that subscribes to the lessee network or E-UTRAN 140a. Said another way, E-UTRAN 140a may be the home network for the wireless device 102.

The DSC 144a, 144b may be configured to send information regarding the availability of spectrum resources (e.g., information received from an eNodeB, MME, PCRF, PCEF, PGW, etc.) to the DPC 146. The DPC 146 may be configured to receive and use such information to intelligently allocate, transfer, manage, coordinate, or lease resources (e.g., the available radio frequency spectrum resources) of the second E-UTRAN 140b for access and use by wireless device subscribers of the first E-UTRAN 140a. For example, the DPC 146 may be configured to coordinate the allocation of spectrum resources to the first E-UTRAN 140a (i.e., lessee network) from the E-UTRAN 140b (i.e., lessor network) as part of the dynamic spectrum arbitrage operations. Such operations may allow a wireless device 102 that is wirelessly connected to the eNodeB 116a in the first E-UTRAN 140a (e.g., via a communication link 152) to be handed off to the eNodeB 116b in the second E-UTRAN 140b. As part of this handoff procedure, the wireless device 102 may establish a new connection 154 to the eNodeB 116b in the second E-UTRAN 140b, terminate the wireless connection 152 to the original eNodeB 116a, and use the allocated resources of the second E-UTRAN 140b as if they are included in the first E-UTRAN 140a. In some embodiments, the components may be configured to perform these DSA and/or handoff operations so that the wireless device 102 may maintain a data connection to (or a data connection that is managed by) the original (lessee) network after the wireless device 102 is handed off to the eNodeB 116b in the second E-UTRAN 140b.

The AE 150 may be configured to utilize features provided by the DSA system 160, and the expandability and renewability characteristics of telecommunication assets, to allocate assets to networks (e.g., E-UTRANs 140a, 140b, etc.) and wireless providers when they are in need of additional resources, and enable investors to invest in the current or future allocations of such resources. For example, the AE 150 component may be configured to allow the second E-UTRAN 140b to dynamically allocate its unused or underutilized resources (e.g., eNodeB 116b) for access and use by wireless devices 102 that subscribe to the first E-UTRAN 140a during periods of high demand or usage. The AE 150 may allow these networks (e.g., E-UTRANs 140a, 140b, etc.) to buy or sell leases and futures contracts in telecommunication assets. The futures contracts may provide an assurance that the seller will allocate/lease a specified quantity of telecommunication assets to the purchaser at a future date for a currently agreed upon price, allowing a purchaser (e.g., UTRAN 140a) to better manage or hedge against future costs and/or to speculate regarding future increases or decreases in the costs or demand for the telecommunication assets.

Each of the GAAs 148a, 148b may be configured to interact with the AE 150 component and its respective DSC 144a, 144b to provide functionality, interfaces, tools that may be used by the wireless network operators (e.g., of E-UTRANs 140a and 140b) to create, select, and administer the resources and leases. For example, the second GAA 148b in the lessor network may send lease attributes to the AE 150 component so that they may be accessed and used by the first GAA 148a in the lessee network.

FIG. 2 illustrates components and information flows in an example DSA system that includes a GAA 148 component configured to manage resources and leases in accordance with various embodiments. In the example illustrated in FIG. 2, the GAA 148 component is coupled to a GAA database (GAADB) 212, and includes a front end module 204, a business module 206, a listener module 208 and a data access module 210. In addition, the GAA 148 component is configured to communicate with a client module 202, a DSC 144 component, and an AE 150 component. In various embodiments, the client module 202 may be a web browser, a computing device of a network operator, a server in the operator network, etc.

The front end module 204 may be configured to interact/communicate with the client module 202 to send and receive information (e.g., bid grids and other graphic representations, lease information, lease parameters, etc.) to and from the operator network and/or to receive inputs from the network operators or users. As part of these operations, the front end module 204 may generate, populate, send, and receive inputs via any or all of a user login 220 screen, an admin login 222 screen, a home 224 screen, a dashboard 226 screen, a create auction 228 screen, a view auctions 230 screen, a resource modify 232 screen, etc. Each of these “screens” may be, or may include, an information structure, object, file, executable code, module, or component that may be used to interact with a user or operator network via the client module 202, such as by causing the client module 202 to display information (e.g., a map, etc.), receive inputs, and/or perform other similar operations.

As examples, the front end module 204 may be configured to use the user login 220 screen to authenticate, authorize, and/or allow users to access various features and functionalities provided by the GAA 148 component. The front end module 204 may use the admin login 222 screen to authenticate, authorize, and/or allow a network operator to manage user accounts (e.g., add, update, or delete users, etc.) and/or to manage the GAADB 212 (e.g., configure the database, reset the database, etc.). This may be accomplished, for example, via the front end module 204 generating the admin login 222 screen, sending the admin login 222 screen to the client module 202, receiving information (e.g., a modified admin login 222 screen, a communication message, etc.) in response to sending the admin login 222 screen to the client module 202, and using the received information to indentify and invoke one or more operations (e.g., read, write, update, delete, etc.) published via an API of the GAADB 212.

The front end module 204 may be configured to use the home 224 screen to provide users or the client module 202 with access to information and functionality for viewing resources, cells or cell sites that are leased (or offered for lessee) on a map, viewing the congestion levels of the cells/cell sites (e.g., on the map), viewing neighbors of the cells/cell sites, as well information and resource (e.g., links, etc.) for navigating to or generating the other screens (e.g., dashboard 226 screen, etc.). For example, the home 224 screen may include a map object that identifies all of the telecommunication resources (e.g., eNodeBs, RF spectrum, etc.) that have been offered for lessee, information suitable for causing the client module 202 to render the map object on an electronic display of a computing device, and other objects or information structure suitable for use in receiving inputs via the displayed map object. In an embodiment, the map object may be a raster map object suitable for rendering raster graphics or raster images. The map object may also be a dot matrix data structure that represents a polygon grid of pixels, points of color, etc. on an electronic display.

The front end module 204 may be configured to use the dashboard 226 screen to display/list all of the saved leases that have not yet been published to AE 150 along with details pertaining to all of the registered DSCs 144 in the system. The dashboard 226 screen may also display a link over a grid id (e.g., in saved leases) that may be used to modify a saved lease and/or to publish a lease to the AE 150. Saved leases may be associated with status of “pending,” and published leases may be associated with the status of “bidding.”

The front end module 204 may be configured to use the create auction 228 screen so as to allow the user or client module 202 to draw/indicate/input a lease polygon on a map (e.g., bounded by 4 to 8 points using a mouse or other pointing device, etc.), enter lease parameters, save a lease to the GAA 148 component, publish a lease to the AE 150 component, and perform other similar operations. The front end module 204 may use the view auctions 230 screen to allow the operators to access and view leases from AE 150 component, analyze the lease for potential bidding, etc. The front end module 204 may be configured to use the resource modify 232 screen to allow the operator to change a telecommunications resource (e.g., select a new resource for the lease, etc.) and to add and remove telecommunications resource to and from a blacklist or a whitelist, etc.

The listener module 208 may be configured to manage communications with the DSC 144 and/or AE 150 components, such as by polling designated communication ports for request messages that are sent to the GAA 148 component and/or for response messages that are sent from the AE 150 component. In some embodiments, the front end module 204 and/or the listener module 208 may be configured to decode received messages into decoded information, and send the decoded information to the business module 206 for processing or analysis.

The business module 206 may be configured to perform operations for accomplishing various functions of the GAA 140 component, including identifying the correct module (e.g., front end module 204, listener module 208, data access module 210, etc.) to which the decoded information is to be sent. For example, the business module 206 may send decoded information to the data access module 210, such as by including a subset of the decoded information as a parameter in an API call to the API published by the data access module 210.

The data access module 210 may be configured to perform various operations to provide various GAA functions, including adding a telecommunication resource (e.g., cell site, eNodeB, etc.) to a lease or auction, removing a telecommunication resource from the lease or auction, adding a lease to the auction or network, deleting a lease (e.g., as part of a resource release request, etc.) or telecommunication resource, and updating congesting information that identifies the current congestion levels of a cell site.

The GAA 140 component may be configured to use (or primarily depend on) spatial data and spatial capabilities to process spatial data stored in the system (e.g., in the GAADB, etc.). To facilitate such spatial data processing, the GAA 140 component may perform GIS operations and/or utilize various GIS applications and processes, such as the PostGIS application. Further, in some embodiments, the GAA 140 component may be configured to use PostGIS as a backend relational database management system. PostGIS is a spatial extension for PostgreSQL object-relational database.

PostGIS adds support for geographic objects (spatial data), allowing location queries to be run in SQL. PostGIS may allow the system to store geographical data types to the core PostgreSQL database (e.g., GAADB). In addition, PostGIS may add functions, operators, and index enhancements that apply to geographical and spatial data types. Example tools and solutions that the GAA 140 component may use in conjunction with the PostGIS system include PostgreSQL, Proj4 projection library, GEOS geometry library, LibXML2, JSON-C and GDAL library.

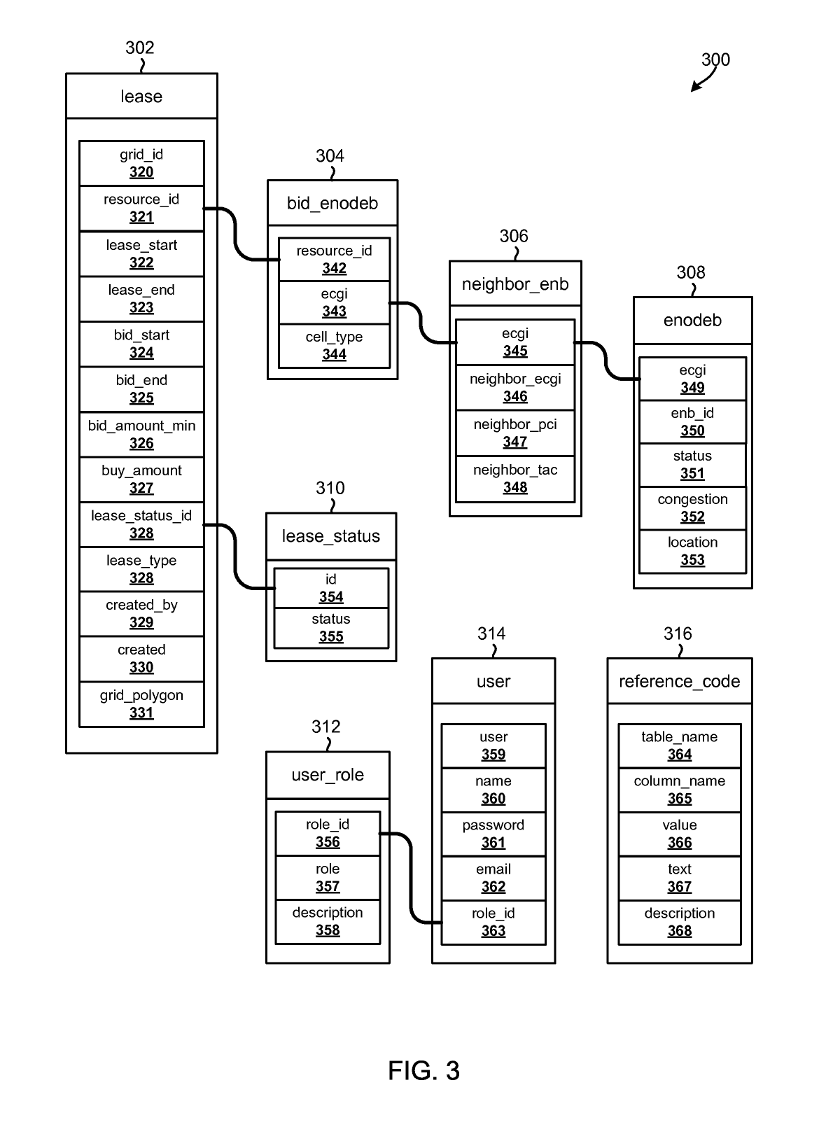

FIG. 3 illustrates an example data model 300 that may be implemented and used by the GAA 140 component to perform GAA operations and/or to accomplish various GAA functions, such as the leasing of wireless mobility telecommunication resources in accordance with the various embodiments. In an embodiment, the data model 300 may be implemented via the GAADB 212 component illustrated in FIG. 2.

In the example illustrated in FIG. 3, the data model 300 includes a lease entity 302, a bid_enodeb entity 304, a neighbor_enb entity 306, an enodeb entity 308, a lease_status entity 310, a user_role entity 312, a user entity 314, and a reference_code entity 316. The lease entity 302 may include various attributes or data fields, such as the illustrated grid_id field 320, resource_id field 321, lease_start field 322, lease_end field 323, bid_start field 324, bid_end field 325, bid_amount_min field 326, buy_amount field 327, lease_status_id field 328, lease_type field 329, created_by field 330, created field 330, and grid_polygon field 331. The bid_enodeb entity 304 may include a resource_id field 342, ecgi field 343, and cell_type field 344. The neighbor_enb entity 306 may include an ecgi field 345, neighbor_ecgi field 346, neighbor_pci field 347, and neighbor_tac field 348. The enodeb entity 308 may include an ecgi field 349, enb_id field 350, status field 351, congestion field 352, and location field 353. The lease_status entity 310 may include an id field 354 and a status field 355. The user_role entity 312 may include a role_id field 356, role field 357, description field 358. The user entity 314 may include a user field 359, name field 360, password field 361, email field 362 and role_id field 363. The reference_code entity 316 may include a table_name field 364, column_name field 365, value field 366, text field 367, and description field 368.

The resource_id field 321 of the lease entity 302 may be linked to (or may be used as a key to) the resource_id field 342 of the bid_enodeb entity 304. Similarly, the ecgi field 343 of the bid_enodeb entity 304 may be linked to the ecgi field 345 of the neighbor_enb entity 306. The ecgi field 345 of the neighbor_enb entity 306 may be linked to the ecgi field 349 of the enodeb entity 308. The lease_status_id field 328 of the lease entity 302 may be linked to the id field 354 of the lease_status entity 310. The role_id field 356 of the user_role entity 312 may be linked to role_id field 363 of the user entity 314. The links may also illustrate the parent-child relationships between these entities or fields/attributes. For example, the bid_enodeb entity 304 may be a child of the lease entity 302, etc.

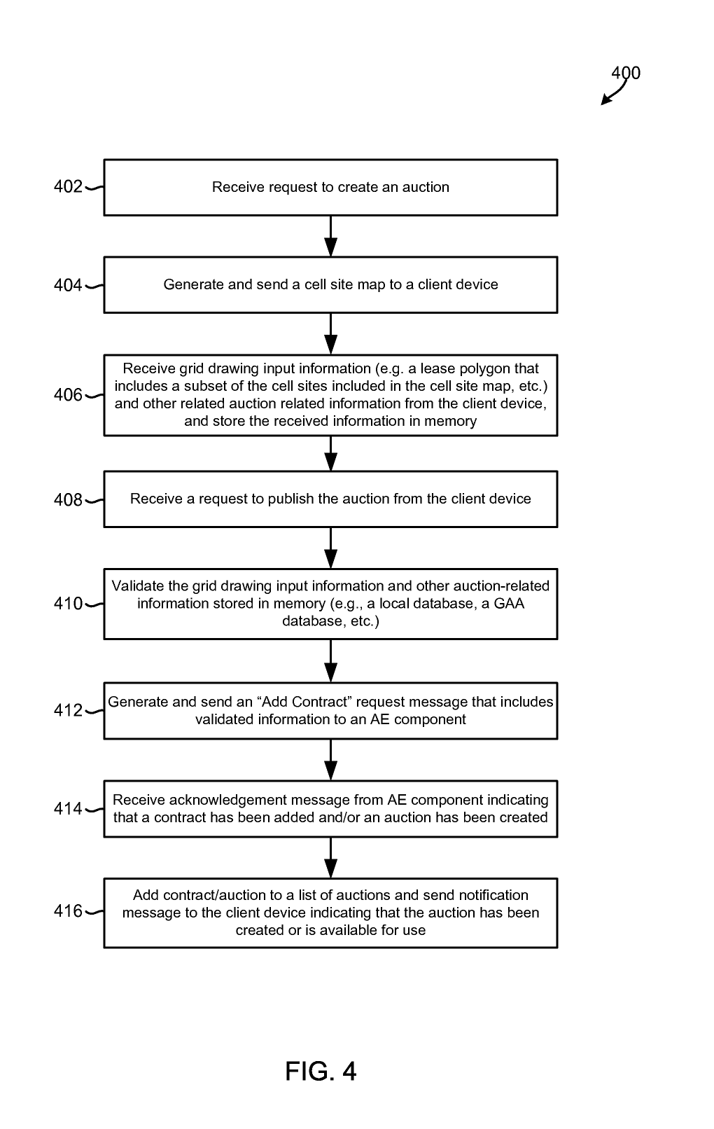

FIG. 4 illustrates an embodiment method 400 for creating a resource auction that may be used by the DSA system to dynamically determine the telecommunication network to which a telecommunication resource is leased or allocated. Method 400 may be performed by a processor or core in a server computing device or computing system that implements all or portions of a GAA 148 component.

In block 402, the server computing device may receive a request to create a new auction from a client device (e.g., in response to a computing system or client module determining that a “Create Auction” link or button has been actuated, etc.). In block 404, the server computing device may generate and send a cell site map (e.g., a map object or information structure, etc.) that include information suitable for identifying all of the telecommunication resources in a specific geographic area and/or the telecommunication resources of one or more participating networks (e.g., a potential lessor network, etc.) to the client device. In an embodiment, in block 404, the server computing device may generate and send a create auction screen 228 (discussed above with reference to FIG. 2) to the client device. The create auction screen 228 may include input fields for receiving information on various auction and bid parameters, such as an operator id, grid polygon (as kml), lease start, lease end, bid start time, bid end time, data volume, minimum amount, buy price, etc. The client device may receive and render the map and various input fields (e.g., textboxes, drop-down boxes, etc.) on its electronic display, and request input from a user. For example, the client device may request that the user draw a polygon on the displayed cell site map to indicate an geographic area or a subset of the telecommunication resources in a cell site map that are to be included in the resource auction.

In block 406, the server computing device may receive a grid drawing input and other auction information input by the user of the client device, and save this information in memory. The grid drawing input may include coordinates or other information (e.g., a lease polygon, bid grid, etc.) that identifies an geographic area and/or a subset of the telecommunication resources included in the a cell site map sent to the client device in block 404. The other auction information may include values for any or all of an operator id, grid polygon, lease start, lease end, bid start time, bid end time, data volume, minimum amount, buy price, and/or any or all of the fields/parameters discussed above with reference to FIG. 3.

In block 408 illustrated in FIG. 4, the server computing device may receive a request to publish the auction from the client device. In block 410, the server computing device may validate the received/stored auction information and attributes (e.g., lease polygon, operator id, etc). For example, in block 410, the server computing device may perform various operations to ensure that the received/stored information includes valid values, identifies valid resources that comply with the system's minimum requirements, is consistent with the rules for participating in an auction, etc.

In block 412, the computing device may generate and send (e.g., via a GAA backend module, etc.) an “Add Contract” request message (including the validated auction information and attributes) to an AE component (e.g., the AE 150 illustrated in FIG. 2). In block 418, the computing device may receive an acknowledgement message from the AE component indicating that a contract and/or auction was successfully created. In block 416, the server computing device may add the auction to a list of resource auctions, and send a notification message to the client to indicate that the auction has been created and/or is ready for use by the participating networks and/or the DSA system.

The lessee and lessor networks may view current ongoing auctions by requesting auction information from the GAA component (e.g., via fetch auctions command), which may obtain such information from the AE component, such as by invoking a “Get Contracts” API of the AE component. For example, after a potential lessee clicks on the fetch button on a view auctions screen (e.g., view auctions 230 illustrated in FIG. 2), the GAA component may request that the AE component determine and send a list of current auctions that the potential lessee is authorized to view. The potential lessee may be provided with the ability to view all existing auctions or a culled list of auctions based on particular attributes associated with auctions in which the potential lessee will be able to participate. The GAA may receive the list of current auctions from the AE component, and use this information to populate the list of auctions in the view auctions screen. In some embodiments, the GAA may include a filter mechanism that filters the list of auctions based on selected criteria or various auction information fields, such as resource id, grid polygon as kml, lease start, lease end, bid start, bid end, volume of data, minimum amount, buy price, etc.

The GAA, after fetching the list of current auctions from the AE, may allow the potential lessee or lessor to view the details of selected auction on the geographical map with bid attributes. For example if the potential lessee is interested in a particular bid, it may use this screen to evaluate the resources and determine whether the resource is viable for bidding. Resources for the bid may be generated based on a polygon definition, the lease parameters may be modified based on operational considerations, and the GAA may allow the Lessor to blacklist, whitelist and change cell type using geographical map (e.g., via the resource modification screen, etc.).

The blacklisting of a telecommunication resource (e.g., eNodeB, a cell site, etc.) may be accomplished using a selection tool in a lease detail screen. For example, a lessor may select a cell on the geographical map and click on blacklist button (e.g., a pull down window, etc.) to add that cell to a blacklist. The GAA may send the blacklist request to a DSC so it can appropriately blacklist that particular cell or sector of the cell from being including in the lease resources. Upon acknowledgement by the DSC that the cell or sector is blacklisted, the GAA may generate a new screen and/or change the color of the selected cell site or sector on the map.

The whitelisting of a telecommunication resource (e.g., eNodeB, a cell site, etc.) enables the lessor to bring a cell/sector into the lease which was initially blacklisted. The lessor may select a blacklisted cells on the geographical map in lease detail page and click on a Whitelist button for further processing. In response, the GAA component may add that resource to the whitelist and sent a whitelisting request to DSC so it can de-blacklist (or remove from the blacklist) a particular cell/sector that is registered in the DSC for that particular lease. Once the cell/sector is whitelisted, the GAA may generate a new screen and/or change the color of the selected cell site or sector on the map (e.g., to the color for an interior, border, or non-lease cell, etc.).

The GAA may also be configured to add, modify, or remove telecommunication resources due to performance issues. This may be accomplished by selecting a resource on the map in the client device, selecting an operation type from a pull down menu, and requesting that the GAA perform the selected operation.

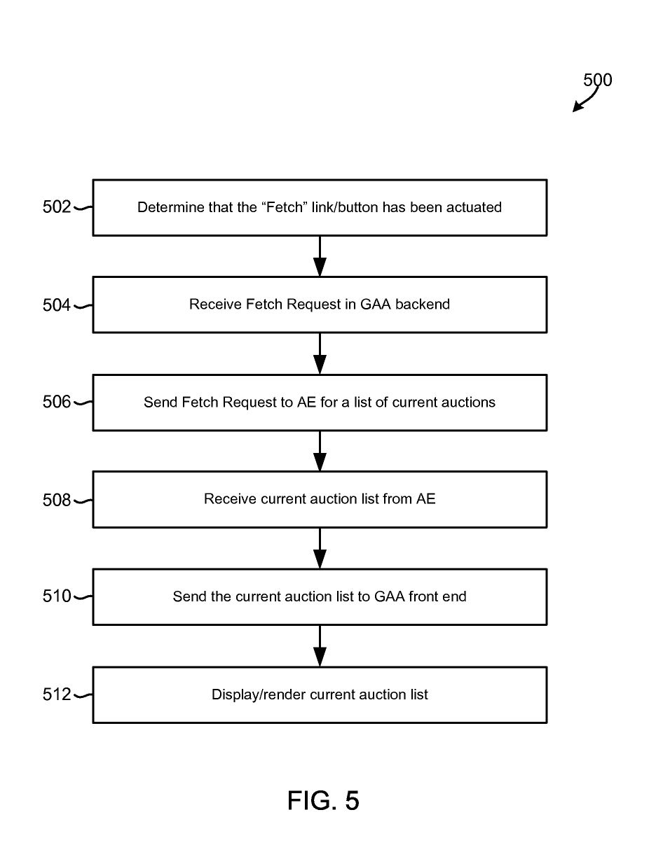

FIG. 5 illustrates a method 500 for rendering a resource auction list in accordance with various embodiments. Method 500 may be performed by a processor or core in a server computing device or computing system that implements all or portions of a GAA 148 component. In block 502, a processor in the server computing device may determine that the “Fetch” link/button has been actuated (e.g., a user, network operator, client module, etc.). In block 504, the processor may receive “Fetch Request” message, such as via a GAA backend (e.g., listener module 208 illustrated in FIG. 2, etc.). In block 506, the processor may send the “Fetch Request” message to an AE component to request a list of current auctions. In block 508, the processor may receive current auction list from the AE component in response to sending the “Fetch Request” message. In block 510, the processor may send the current auction list to an GAA front end component, such as the front end module 204 illustrated in FIG. 2. In block 512, the processor may cause the server computing device to display or render the current auction list to the user, such as by generating and sending a view auctions 230 screen to a client module 202.

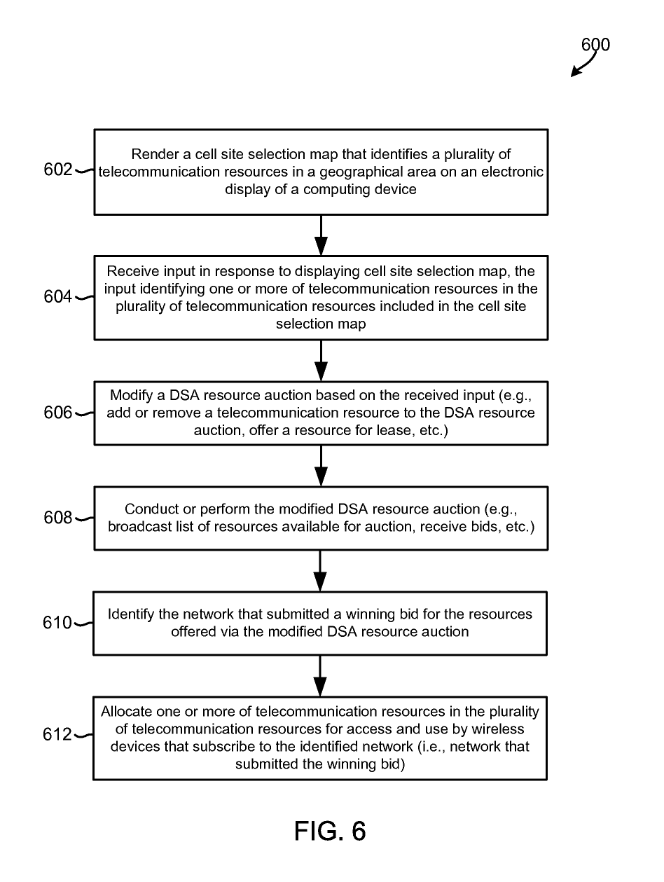

FIG. 6 illustrates a method 600 for rendering various embodiments. Method 500 may be performed by a processor or core in a server computing device or computing system that implements all or portions of a GAA 148 component. In block 602, the processor may perform various operations to render a cell site selection map that identifies a plurality of telecommunication resources in a geographical area on an electronic display of a computing device. For example, the processor may generate and send a home 224 or dashboard 226 screen to a client module 202 in block 602. In block 604, the processor may receive input in response to causing the cell site selection map to be displayed/rendered. The received input information may identify one or more of the telecommunication resources included in the plurality of telecommunication resources that were included in and displayed via the cell site selection map. In block 606, the processor may use the received input information to modify a DSA resource auction, such as by adding or removing a telecommunication resource to the DSA resource auction, offering a new telecommunication resource for lease, changing a characteristic of an offered resource, etc.

In block 608, the processor may conduct or perform the modified DSA resource auction. For example, the processor may determine whether a telecommunication resource of a first communication network in a plurality of communication networks is available for allocation, broadcasting a communication signal that includes information suitable for informing the plurality of communication networks that the telecommunication resource is available for allocation via auction and which includes an auction start time for the auction, receive credential information (e.g., information identifying a type of geographic area, a wireless access technology, a frequency of operation, an amount of bandwidth, a duration for use of the telecommunication resource, a start time, an end time, etc.) from the plurality of communication networks, use the received credential information to determine that one or more networks in the plurality of communication networks (e.g., a second communication network) is eligible to participate in the auction, receive bids from the plurality of communication networks for the telecommunication resource, and accept only the bids received from the plurality of communication networks determined to be eligible to participate in the auction and after the auction start time included in the broadcast communication signal.

In block 610, the processor may identify the network (e.g., the second communication network) that submitted a winning bid for the resources offered via the modified DSA resource auction. In block 612, the processor may allocate the telecommunication resources for access and use by wireless devices that subscribe to the identified network (i.e., network that submitted the winning bid or the second communication network). As part of the operations in block 610, the processor may send a communication message to the identified network (e.g., the second communication network) to inform that network that use of the allocated telecommunication resource may begin, and record a transaction in a transaction database identifying the telecommunication resource as being allocated for use by the identified network.

In an embodiment, the processor may be configured to perform various DSA operations, which may include establishing a first communication link between a communications server and a first server in the first communication network, wherein an amount of RF spectrum resources is controlled by the first communication network, establishing a second communication link between the communications server and a second server in a second communication network, receiving in the communications server a request for radio frequency (RF) spectrum resources from the second server, determining in the communications server an amount of RF spectrum resources available for allocation within the first communication network by monitoring communications in the first communication network, determining an amount of RF spectrum resources in use by the first communication network based on a result of the monitoring, computing a difference between the amount of RF spectrum resources controlled by the first communication network and the determined amount of RF spectrum resources in use, and setting the amount of RF spectrum resources available for allocation based on the computed difference, pooling available RF spectrum resources from the first communication network and at least one other communication network, dynamically allocating a portion of the available RF spectrum resources of the first communication network for access and use by multiple cell sites in the second communication network from the pool of available RF spectrum resources, informing the second server that use of allocated RF spectrum resources may begin, recording a transaction in a transaction database identifying an amount of RF spectrum resources allocated for use by the second communication network, and/or terminating use of the RF spectrum resources by the second communication network when the allocated RF spectrum resources are required by the first communication network.

In an embodiment, DSA operations may include determining (e.g., in a communications server) that a telecommunication resource of a first communication network is available for allocation, broadcasting a first communication signal informing a plurality of communication networks that the telecommunication resource is available for allocation and of a geographical area associated with the telecommunication resource, negotiating a resource leasing scheme between the first communication network and a second communication network in the plurality of communication networks for a use of the telecommunication resource, coordinating a handover of a mobile device between the first and second communication networks based on geographic boundaries defined in the resource leasing scheme, allocating the telecommunication resource of the first communication network for access and use by the second communication network, broadcasting a second communication signal informing the second communication network that use of allocated telecommunication resource may begin in the geographical area, and recording a transaction in a transaction database identifying the telecommunication resource as being allocated for use by the second communication network.

DSA operations may further include receiving resource configuration information relating to a resource allocation scheme from a first dynamic spectrum controller server in the first communication network, and sending the resource configuration information to a second dynamic spectrum controller server in the second communication network. The DSA operations may also include receiving coordination information relating to availability of the telecommunication resource based on geographical areas from a first dynamic spectrum controller server in the first communication network, and sending the coordination information to a second dynamic spectrum controller server in the second communication network. The DSA operations may also include determining a validity of a subscriber device of the second communication network based on a proximity of the subscriber device to the geographical area and information included in the resource leasing scheme.

The DSA operations may further include instructing a subscriber device of the second communication network to establish a communication link to a component in the first communication network based on a proximity of the subscriber device to the geographical area and terms included in the resource leasing scheme. The DSA operations may also include determining a validity of a subscriber device of the second communication network based on a proximity of the subscriber device to the geographical area and level of quality of service available to the subscriber device, instructing a subscriber device of the second communication network to establish a communication link to a component in the first communication network based on a proximity of the subscriber device to the geographical area and a level of quality of service available to the subscriber device, instructing a subscriber device of the second communication network to change networks based on a proximity of the subscriber device to the geographical area, instructing a subscriber device of the second communication network that is actively connected to the telecommunication resource to change networks, and/or instructing a subscriber device of the second communication network using the allocated telecommunication resource to attach to another resource in the first communication network based on a proximity of the subscriber device to the geographical area.

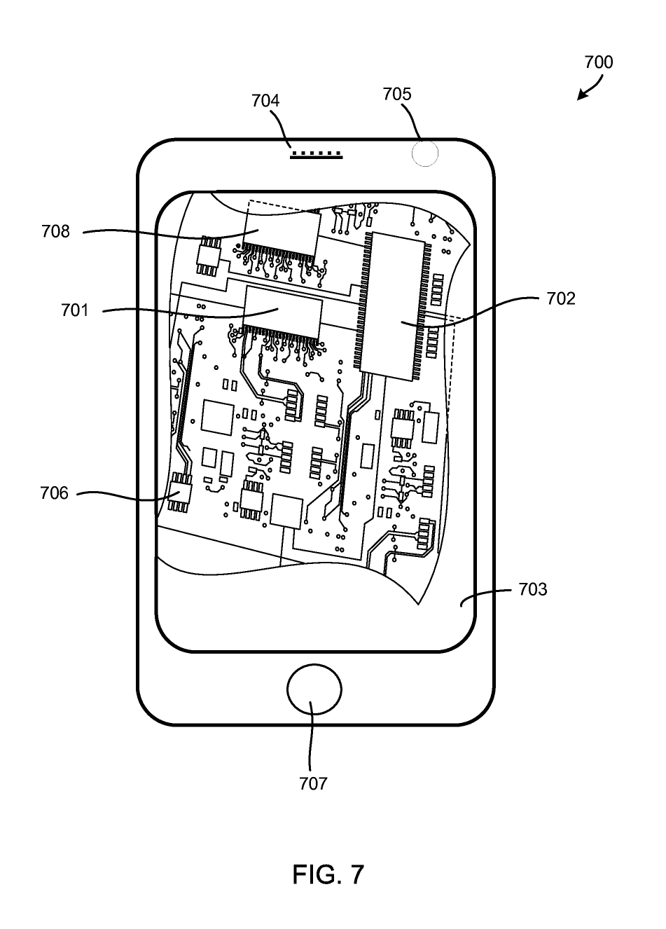

The various embodiments may be implemented on a variety of wireless computing devices, an example of which is illustrated in FIG. 7. Specifically, FIG. 7 is a system block diagram of a wireless transceiver device in the form of a smartphone/cell phone 700 suitable for use with any of the embodiments. The cell phone 700 may include a processor 701 coupled to internal memory 702, a display 703, and to a speaker 704. Additionally, the cell phone 700 may include an antenna 705 for sending and receiving electromagnetic radiation that may be connected to a wireless data link and/or cellular telephone transceiver 706 coupled to the processor 701. Cell phones 700 typically also include menu selection buttons or rocker switches 707 for receiving user inputs.

A typical cell phone 700 also includes a sound encoding/decoding (CODEC) circuit 708 which digitizes sound received from a microphone into data packets suitable for wireless transmission and decodes received sound data packets to generate analog signals that are provided to the speaker 704 to generate sound. The cell phone 700 may further include a ZigBee transceiver (i.e., an IEEE 802.15.4 transceiver) for low-power short-range communications between wireless devices, or other similar communication circuitry (e.g., circuitry implementing the Bluetooth® or WiFi protocols, etc.).

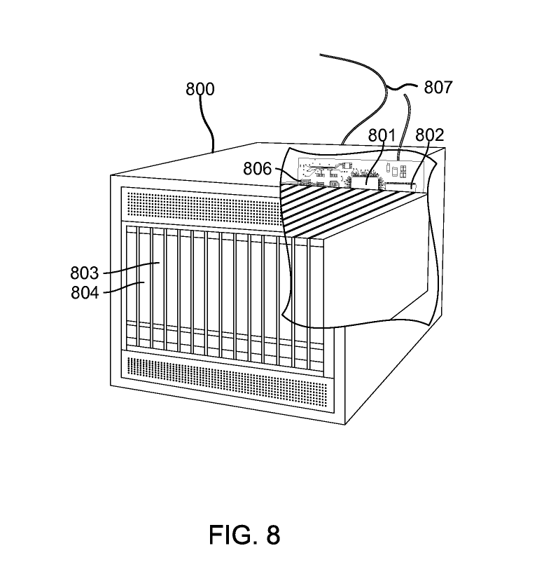

The embodiments described above, including the spectrum arbitrage and GAA functions, may be implemented within a telecommunication system on any of a variety of commercially available server devices, such as the server 800 illustrated in FIG. 8. Such a server 800 typically includes a processor 801 coupled to volatile memory 802 and a large capacity nonvolatile memory, such as a disk drive 803. The server 800 may also include a floppy disc drive, compact disc (CD) or DVD disc drive 804 coupled to the processor 801. The server 800 may also include network access ports 806 coupled to the processor 801 for establishing data connections with a network 807, such as a local area network coupled to other communication system computers and servers.

The processors 701, 801, may be any programmable microprocessor, microcomputer or multiple processor chip or chips that can be configured by software instructions (applications) to perform a variety of functions, including the functions of the various embodiments described below. In some devices, multiple processors may be provided, such as one processor dedicated to wireless communication functions and one processor dedicated to running other applications. Typically, software applications may be stored in the internal memory 702, 802, before they are accessed and loaded into the processor 701, 801. The processor 701, 801 may include internal memory sufficient to store the application software instructions. In some servers, the processor 701, 801 may include internal memory sufficient to store the application software instructions. In some receiver devices, the secure memory may be in a separate memory chip coupled to the processor 701, 801. The internal memory 702, 802 may be a volatile or nonvolatile memory, such as flash memory, or a mixture of both. For the purposes of this description, a general reference to memory refers to all memory accessible by the processor 701, 801, including internal memory 702, 802, removable memory plugged into the device, and memory within the processor 701, 801 itself.

As used in this application, the terms “component,” “module,” “balancer” and the like are intended to include a computer-related entity, such as, but not limited to, hardware, firmware, a combination of hardware and software, software, or software in execution, which are configured to perform particular operations or functions. For example, a component may be, but is not limited to, a process running on a processor, a processor, an object, an executable, a thread of execution, a program, a computer, a server, network hardware, etc. By way of illustration, both an application running on a computing device and the computing device may be referred to as a component. One or more components may reside within a process and/or thread of execution and a component may be localized on one processor or core and/or distributed between two or more processors or cores. In addition, these components may execute from various non-transitory computer readable media having various instructions and/or data structures stored thereon.

A number of different cellular and mobile communication services and standards are available or contemplated in the future, all of which may implement and benefit from the various embodiments. Such services and standards include, e.g., third generation partnership project (3GPP), long term evolution (LTE) systems, third generation wireless mobile communication technology (3G), fourth generation wireless mobile communication technology (4G), global system for mobile communications (GSM), universal mobile telecommunications system (UMTS), 3GSM, general packet radio service (GPRS), code division multiple access (CDMA) systems (e.g., cdmaOne, CDMA2000™), enhanced data rates for GSM evolution (EDGE), advanced mobile phone system (AMPS), digital AMPS (IS-136/TDMA), evolution-data optimized (EV-DO), digital enhanced cordless telecommunications (DECT), Worldwide Interoperability for Microwave Access (WiMAX), wireless local area network (WLAN), public switched telephone network (PSTN), Wi-Fi Protected Access I & II (WPA, WPA2), Bluetooth®, integrated digital enhanced network (iden), land mobile radio (LMR), and evolved universal terrestrial radio access network (E-UTRAN). Each of these technologies involves, for example, the transmission and reception of voice, data, signaling and/or content messages. It should be understood that any references to terminology and/or technical details related to an individual telecommunication standard or technology are for illustrative purposes only, and are not intended to limit the scope of the claims to a particular communication system or technology unless specifically recited in the claim language.

The foregoing method descriptions and the process flow diagrams are provided merely as illustrative examples and are not intended to require or imply that the steps of the various embodiments must be performed in the order presented. As will be appreciated by one of skill in the art the order of steps in the foregoing embodiments may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the embodiments disclosed herein may be implemented or performed with a general purpose processor, a digital signal processor (DPC), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine A processor may also be implemented as a combination of computing devices, e.g., a combination of a DPC and a microprocessor, a plurality of microprocessors, one or more microprocessors in conjunction with a DPC core, or any other such configuration. Alternatively, some steps or methods may be performed by circuitry that is specific to a given function.

In one or more exemplary embodiments, the functions described may be implemented in hardware, software, firmware, or any combination thereof. If implemented in software, the functions may be stored as one or more instructions or code on a non-transitory computer-readable medium or non-transitory processor-readable medium. The steps of a method or algorithm disclosed herein may be embodied in a processor-executable software module which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

What is claimed is:

1. A dynamic spectrum arbitrage (DSA) method, comprising:
rendering on an electronic display of a computing device a cell site selection map that identifies a plurality of telecommunication resources in a geographical area;
receiving input in the displayed cell site selection map selecting one or more of telecommunication resources in the plurality of telecommunication resources; and
modifying a DSA resource auction based on the received input.

2. The DSA method of claim 1, wherein modifying a DSA resource auction based on the received input comprises adding or removing a telecommunication resource to the DSA resource auction.

3. The DSA method of claim 1, further comprising performing operations to accomplish one or more of a login authentication function, an auctions dashboard function, a create auction function, a view auctions function, a resource modify function, a lease management function, a telecommunication resource/asset management function, and a bid grid management function.

4. The DSA method of claim 3, wherein performing operations to accomplish one or more of a login authentication function, an auctions dashboard function, a create auction function, a view auctions function, a resource modify function, a lease management function, a telecommunication resource/asset management function, and a bid grid management function comprises performing operations selected from the group comprising:
administering a telecommunication resource allocation scheme;
creating a resource auction;
listing resources available for the auction;
displaying information about the resources that are offered via the auction, the information including congestion level information;
generating a lease for the use the resources in a geographical area identified via the cell site selection map;
managing telecommunication resources offered for lease;
managing functionalities of the telecommunication resources offered for lease;
generating a bid grid;
updating the bid grid; and
providing cell type classification list information for each telecommunication resource associated with the bid grid.

5. The DSA method of claim 1, wherein the computing device is included in a first telecommunication network of a plurality of communication networks, the method further comprising:
conducting the DSA resource auction by:
establishing a communication link between a communications server and the plurality of communication networks;
determining in the communications server whether a telecommunication resource of the first communication network of the plurality of communication networks is available for allocation based on information received via the communication link;
broadcasting a communication signal that includes information suitable for informing the plurality of communication networks that the telecommunication resource is available for allocation via auction and including an auction start time for the auction;
receiving credential information from the plurality of communication networks, the credential information identifying a type of geographic area, a wireless access technology, a frequency of operation, an amount of bandwidth, a duration for use of the telecommunication resource, a start time, and an end time;
using the received credential information to determine that one or more networks in the plurality of communication networks is eligible to participate in the auction, wherein the one or more communication networks determined to be eligible to participate in the auction includes a second communication network;
receiving bids from the plurality of communication networks for the telecommunication resource determined to be available for allocation in response to broadcasting the communication message and after the auction start time included in the broadcast communication signal;
accepting only the bids received from the plurality of communication networks determined to be eligible to participate in the auction;
allocating the telecommunication resource of the first communication network for access and use by the second communication network in the plurality of communication networks based on accepted bids;
sending a communication message to the second communication network, the communication message including information suitable for informing the second communication network that use of allocated telecommunication resource may begin; and
recording a transaction in a transaction database identifying the telecommunication resource as being allocated for use by the second communication network.

6. The DSA method of claim 1, wherein the computing device is included in a first telecommunication network of a plurality of communication networks, the method further comprising:
establishing a first communication link between a communications server and a first server in the first communication network, wherein an amount of RF spectrum resources is controlled by the first communication network;
establishing a second communication link between the communications server and a second server in a second communication network;
receiving in the communications server a request for radio frequency (RF) spectrum resources from the second server;
determining in the communications server an amount of RF spectrum resources available for allocation within the first communication network;
dynamically allocating a portion of the available RF spectrum resources of the first communication network for access and use by multiple cell sites in the second communication network from a pool of available RF spectrum resources;
informing the second server that use of allocated RF spectrum resources may begin; and
recording a transaction in a transaction database identifying an amount of RF spectrum resources allocated for use by the second communication network.

7. A server computing device deployed as part of a dynamic spectrum arbitrage (DSA) system and coupled to a dynamic spectrum controller in a first communication network, the server computing comprising a processor configured with processor-executable instructions to perform operations comprising:
rendering a cell site selection map that identifies a plurality of telecommunication resources in a geographical area;
receiving input in the displayed cell site selection map selecting one or more of telecommunication resources in the plurality of telecommunication resources; and
modifying a DSA resource auction based on the received input.

8. The server computing device of claim 7, wherein the processor is configured with processor executable instructions to perform operations such that modifying a DSA resource auction based on the received input comprises sending a communication message to the dynamic spectrum controller to add or remove a telecommunication resource to the DSA resource auction.

9. The server computing device of claim 7, wherein the processor is further configured with processor executable instructions to perform operations to accomplish one or more of a login authentication function, an auctions dashboard function, a create auction function, a view auctions function, a resource modify function, a lease management function, a telecommunication resource/asset management function, and a bid grid management function.

10. The server computing device of claim 8, wherein the processor is further configured with processor executable instructions to perform operations such that performing operations for accomplishing or more of a login authentication function, an auctions dashboard function, a create auction function, a view auctions function, a resource modify function, a lease management function, a telecommunication resource/asset management function, and a bid grid management function comprises performing operations selected from the group comprising:
administering a telecommunication resource allocation scheme;
creating a resource auction;
listing resources available for the auction;
displaying information about the resources that are offered via the auction, the information including congestion level information;
generating a lease for the use the resources in a geographical area identified via the cell site selection map;
managing telecommunication resources offered for lease;
managing functionalities of the telecommunication resources offered for lease;
generating a bid grid;
updating the bid grid; and
providing cell type classification list information for each telecommunication resource associated with the bid grid.

11. The server computing device of claim 7, wherein the processor is configured with processor executable instructions to perform operations such that modifying a DSA resource auction based on the received input comprises communicating with a communication device that is configured to conduct the DSA resource auction by:
establishing a communication link between the communication device and a plurality of communication networks;
determining whether a telecommunication resource of the first communication network in the plurality of communication networks is available for allocation based on information received via the communication link;
broadcasting a communication signal that includes information suitable for informing the plurality of communication networks that the telecommunication resource is available for allocation via auction and including an auction start time for the auction;
receiving credential information from the plurality of communication networks, the credential information identifying a type of geographic area, a wireless access technology, a frequency of operation, an amount of bandwidth, a duration for use of the telecommunication resource, a start time, and an end time;
using the received credential information to determine that one or more networks in the plurality of communication networks is eligible to participate in the auction, wherein the one or more communication networks determined to be eligible to participate in the auction includes a second communication network;
receiving bids from the plurality of communication networks for the telecommunication resource determined to be available for allocation in response to broadcasting the communication message and after the auction start time included in the broadcast communication signal;
accepting only the bids received from the plurality of communication networks determined to be eligible to participate in the auction;
allocating the telecommunication resource of the first communication network for access and use by the second communication network in the plurality of communication networks based on accepted bids;
sending a communication message to the second communication network, the communication message including information suitable for informing the second communication network that use of allocated telecommunication resource may begin; and
recording a transaction in a transaction database identifying the telecommunication resource as being allocated for use by the second communication network.

12. The server computing device of claim 7, wherein the processor is configured with processor executable instructions to perform operations such that modifying a DSA resource auction based on the received input comprises communicating with communicating with a communications server that is configured to perform DSA operations by:
establishing a first communication link between the communications server and a first server in the first communication network, wherein an amount of RF spectrum resources is controlled by the first communication network;
establishing a second communication link between the communications server and a second server in a second communication network;
receiving in the communications server a request for radio frequency (RF) spectrum resources from the second server;
determining in the communications server an amount of RF spectrum resources available for allocation within the first communication network;
dynamically allocating a portion of the available RF spectrum resources of the first communication network for access and use by multiple cell sites in the second communication network from a pool of available RF spectrum resources;
informing the second server that use of allocated RF spectrum resources may begin; and
recording a transaction in a transaction database identifying an amount of RF spectrum resources allocated for use by the second communication network.

13. A non-transitory computer readable storage medium having stored thereon processor-executable software instructions configured to cause a processor of a server computing device deployed as part of a dynamic spectrum arbitrage (DSA) system and coupled to a dynamic spectrum controller in a first communication network to perform operations comprising:
rendering a cell site selection map that identifies a plurality of telecommunication resources in a geographical area;
receiving input in the displayed cell site selection map selecting one or more of telecommunication resources in the plurality of telecommunication resources; and
modifying a DSA resource auction based on the received input.

14. The non-transitory computer readable storage medium of claim 13, wherein the stored processor-executable software instructions are configured to cause a processor to perform operations such that modifying a DSA resource auction based on the received input comprises sending a communication message to the dynamic spectrum controller to add or remove a telecommunication resource to the DSA resource auction.

15. The non-transitory computer readable storage medium of claim 13, wherein the stored processor-executable software instructions are configured to cause a processor to perform operations to accomplish one or more of a login authentication function, an auctions dashboard function, a create auction function, a view auctions function, a resource modify function, a lease management function, a telecommunication resource/asset management function, and a bid grid management function.

16. The non-transitory computer readable storage medium of claim 15, wherein the stored processor-executable software instructions are configured to cause a processor to perform operations such that performing operations for accomplishing or more of a login authentication function, an auctions dashboard function, a create auction function, a view auctions function, a resource modify function, a lease management function, a telecommunication resource/asset management function, and a bid grid management function comprises performing operations selected from the group comprising:
administering a telecommunication resource allocation scheme;
creating a resource auction;
listing resources available for the auction;
displaying information about the resources that are offered via the auction, the information including congestion level information;
generating a lease for the use the resources in a geographical area identified via the cell site selection map;
managing telecommunication resources offered for lease;
managing functionalities of the telecommunication resources offered for lease;
generating a bid grid;
updating the bid grid; and
providing cell type classification list information for each telecommunication resource associated with the bid grid.

17. The non-transitory computer readable storage medium of claim 13, wherein the stored processor-executable software instructions are configured to cause a processor to perform operations such that modifying a DSA resource auction based on the received input comprises communicating with a communication device that is configured to conduct the DSA resource auction by:
establishing a communication link between the communication device and a plurality of communication networks;
determining whether a telecommunication resource of the first communication network in the plurality of communication networks is available for allocation based on information received via the communication link;
broadcasting a communication signal that includes information suitable for informing the plurality of communication networks that the telecommunication resource is available for allocation via auction and including an auction start time for the auction;
receiving credential information from the plurality of communication networks, the credential information identifying a type of geographic area, a wireless access technology, a frequency of operation, an amount of bandwidth, a duration for use of the telecommunication resource, a start time, and an end time;
using the received credential information to determine that one or more networks in the plurality of communication networks is eligible to participate in the auction, wherein the one or more communication networks determined to be eligible to participate in the auction includes a second communication network;
receiving bids from the plurality of communication networks for the telecommunication resource determined to be available for allocation in response to broadcasting the communication message and after the auction start time included in the broadcast communication signal;
accepting only the bids received from the plurality of communication networks determined to be eligible to participate in the auction;
allocating the telecommunication resource of the first communication network for access and use by the second communication network in the plurality of communication networks based on accepted bids;
sending a communication message to the second communication network, the communication message including information suitable for informing the second communication network that use of allocated telecommunication resource may begin; and
recording a transaction in a transaction database identifying the telecommunication resource as being allocated for use by the second communication network.

18. The non-transitory computer readable storage medium of claim 13, wherein the stored processor-executable software instructions are configured to cause a processor to perform operations such that modifying a DSA resource auction based on the received input comprises communicating with communicating with a communications server that is configured to perform DSA operations by:
establishing a first communication link between the communications server and a first server in the first communication network, wherein an amount of RF spectrum resources is controlled by the first communication network;
establishing a second communication link between the communications server and a second server in a second communication network;
receiving in the communications server a request for radio frequency (RF) spectrum resources from the second server;
determining in the communications server an amount of RF spectrum resources available for allocation within the first communication network;
dynamically allocating a portion of the available RF spectrum resources of the first communication network for access and use by multiple cell sites in the second communication network from a pool of available RF spectrum resources;
informing the second server that use of allocated RF spectrum resources may begin; and
recording a transaction in a transaction database identifying an amount of RF spectrum resources allocated for use by the second communication network.
